(19) United States
(12) Patent Application Publication
(10) Pub. No.: US 2026/0010120 A1
(43) Pub. Date: Jan. 8, 2026

(54) MECHANISM FOR A STRIKING TIMEPIECE

(71) Applicant: BULGARI HORLOGERIE SA, Neuchâtel (CH)

(72) Inventors: Fabrice Rochat, Vallorbe (CH); Julien Behra, Les Rousses (FR)

(73) Assignee: BULGARI HORLOGERIE SA, Neuchâtel (CH)

(21) Appl. No.: 19/104,464

(22) PCT Filed: Aug. 18, 2023
(86) PCT No.: PCT/EP2023/072857

§ 371 Date: Mar. 14, 2025

(30) Foreign Application Priority Data
Aug. 18, 2022 (FR) FR2208360

(51) Int. Cl. G04B 21/06; G04B 13/02; G04B 21/04

(52) U.S. Cl. CPC G04B 21/06; G04B 13/02; G04B 21/04

(57) ABSTRACT

The mechanism (100) for a striking timepiece includes a first, and a second cannon pinions, a geared connection (14,15,21) between the first (1) and second (2) cannon pinions, and—a device (16) for compensating clearance in the geared connection. The geared connection (14,15,21) includes a first gear (15) attached to the first cannon pinion (1),—a second gear (14) mounted pivotably relative to the first cannon pinion, and—a third gear (21) attached to the second cannon pinion (2). The first and second gears mesh with the third gear, and the clearance compensation device (16) in the geared connection is arranged so as to exert a return force from the first and second gears against the opposing faces of at least one tooth of the third gear (21) and/or—the adjacent faces of at least two consecutive teeth of the third gear (21).

### TECHNICAL FIELD OF THE INVENTION

The invention relates to a mechanism for a timepiece movement. The invention also relates to a timepiece movement comprising such a mechanism. The invention finally relates to a timepiece comprising such a mechanism and/or such a movement.

### BACKGROUND ART

A timepiece striking mechanism is highly complex. It is complex because of the number and nature of the kinematic connections between its components.

Usually, in striking mechanisms, notably in classic repeating striking mechanisms, a minutes snail, namely a cam with notches for regulating the minutes striking work, which collaborates with a feeler of a minutes piece, is fixed directly to a cannon pinion which at its end bears a minute hand. Such an arrangement ensures a mechanism in which there is no offset between the position of the minute hand against the minutes scale of the dial and the number of minute strikes struck. The same goes for the quarter-hour snail, this being a cam with notches for regulating the quarter-hour striking work, which collaborates with a feeler of a quarter-hour piece.

Such architecture presents problems with the mounting and the setting of the snails to ensure that the strikes are perfectly synchronized with the position of the hands.

### SUMMARY OF THE INVENTION

The aim of the invention is to provide a mechanism which overcomes the aforementioned drawbacks and improves on the mechanisms known from the prior art. In particular, the invention proposes a mechanism that is simple and makes it easier for the cams of the striking mechanism to be fitted and for the striking mechanism to be synchronized with the timepiece display.

A first aspect of the invention relates to a mechanism as defined in point 1 below.
1. A mechanism for a striking timepiece movement, comprising:
   a first cannon pinion,
   a second cannon pinion,
   a geared connection between the first cannon pinion and the second cannon pinion, and
   a device for compensating for the lash in the geared connection,
the geared connection between the first cannon pinion and the second cannon pinion comprising:
   a first wheel fixed on the first cannon pinion,
   a second wheel pivot-mounted relative to the first cannon pinion, and
   a third wheel fixed on the second cannon pinion,
the first and second wheels meshing with the third wheel, and
the device for compensating for the lash in the geared connection being arranged in such a way as to apply a return force returning the first and second wheels against:
   the opposite flanks of at least one tooth of the third wheel, and/or
   the adjacent flanks of at least two consecutive teeth of the third wheel.

According to the first aspect of the invention, a number of embodiments of the mechanism are defined in points 2 to 6 below.
2. The mechanism as defined in point 1, wherein the lash-compensation device comprises an element for regulating the return force, the regulating element comprising for example grippable notching to allow the second gearwheel to be rotated relative to the first cannon pinion.
3. The mechanism as defined in one of the preceding points, wherein the lash-compensation device comprises a spring, notably a leaf spring, fixed:
   firstly, notably at one of its ends, to the first cannon pinion, and
   secondly, notably at the other of its ends, to the second wheel.
4. The mechanism as defined in the preceding point, wherein the spring is fixed:
   at one of its ends to the second wheel using a pin, and
   at the other of its ends to the first cannon pinion via a ring that belongs to the spring.
5. The mechanism as defined in one of the preceding points, wherein the first cannon pinion is intended to take a first minutes indicator, such as a minute hand.
6. The mechanism as defined in one of the preceding points, wherein the second cannon pinion is intended to take at least a striking-work cam, notably a minutes snail and/or a surprise piece and/or a quarter-hour snail.

According to the first aspect of the invention, a timepiece movement is defined by point 7 below.
7. A timepiece movement comprising:
   a mechanism as defined in one of the preceding points, and
   a finishing gear driving one of the first and second cannon pinions.

According to the first aspect of the invention, one embodiment of the movement is defined by point 8 below.
8. The timepiece movement as defined in the preceding point, wherein the movement comprises a frame, notably a mainplate, wherein the first cannon pinion is mounted on the dial side of the frame and the second cannon pinion is mounted on the bridge side of the frame.

According to the first aspect of the invention, a timepiece is defined by point 9 below.
9. A timepiece, notably a striking wristwatch, comprising:
   a mechanism as defined in one of points 1 to 6, and/or
   a timepiece movement as defined in one of points 7 and 8.

According to a second aspect of the invention, subject matter is defined by the following proposals:
1. A mechanism (100) for a striking timepiece movement (200), comprising:
   a first cannon pinion (1),
   a second cannon pinion (2),
   a geared connection (14, 15, 21) between the first cannon pinion (1) and the second cannon pinion (2), and
   a device (16) for compensating for the lash in the geared connection.
2. A mechanism (100) according to proposal 1, wherein the geared connection (14, 15, 21) between the first cannon pinion (1) and the second cannon pinion (2) comprises:
   a first wheel (15) fixed on the first cannon pinion (1),
   a second wheel (14) pivot-mounted relative to the first cannon pinion, and
   a third wheel (21) fixed on the second cannon pinion (2),
the first and second wheels meshing with the third wheel, and
the device (16) for compensating for the lash in the geared connection being arranged in such a way as to apply a return force returning the first and second wheels against:
   the opposite flanks of at least one tooth of the third wheel (21), and/or
   the adjacent flanks of at least two consecutive teeth of the third wheel (21).
3. A mechanism (100) according to proposal 2, wherein the lash-compensation device (16) comprises an element (131) for regulating the return force, the regulating element (131) comprising for example grippable notching (131) to allow the second gearwheel (14) to be rotated relative to the first cannon pinion (1).
4. A mechanism (100) according to one of proposals 1 to 3, wherein the lash-compensation device (16) comprises a spring (16), notably a leaf spring (16), fixed:
   firstly, notably at one of its ends, to the first cannon pinion (1), and
   secondly, notably at the other of its ends, to the second wheel (14).
5. A mechanism (100) according to proposals 2 and 4, wherein the spring (16) is fixed:
   at one of its ends to the second wheel (14) using a pin (163), and
   at the other of its ends to the first cannon pinion (1) via a ring (161) that belongs to the spring (16).
6. A mechanism (100) according to one of proposals 1 to 5, wherein the first cannon pinion (1) is intended to take a first minutes indicator, such as a minute hand (61).
7. A mechanism (100) according to one of proposals 1 to 6, wherein the second cannon pinion (2) is intended to take at least a striking-work cam (22, 23, 24), notably a minutes snail (22) and/or a surprise piece (23) and/or a quarter-hour snail (24).
8. A timepiece movement (200) comprising:
   a mechanism (100) according to one of proposals 1 to 7, and
   a finishing gear (99) driving one of the first and second cannon pinions (1, 2).
9. A timepiece movement (200) according to proposal 8, wherein the movement comprises a frame (90), notably a mainplate (91), wherein the first cannon pinion (1) is mounted on the dial side of the frame and the second cannon pinion (2) is mounted on the bridge side of the frame.
10. A timepiece (300), notably a striking wristwatch (300), comprising:
   a mechanism (100) according to one of proposals 1 to 7, and/or
   a timepiece movement (200) according to one of proposals 8 and 9.

### BRIEF DESCRIPTION OF THE DRAWINGS

The subjects, features and advantages of the present invention are set out in detail in the following description of a particular non-limiting embodiment given with respect to the appended figures.

FIG. 1 is a partial sectional view of one embodiment of a timepiece according to the invention.

FIG. 2 is a schematic cross-sectional and perspective view of the embodiment of the timepiece.

FIG. 3 is a schematic perspective view of the embodiment of the timepiece.

FIG. 4 is a perspective view of part of the embodiment of the timepiece.

### DETAILED DESCRIPTION OF PARTICULAR EMBODIMENTS

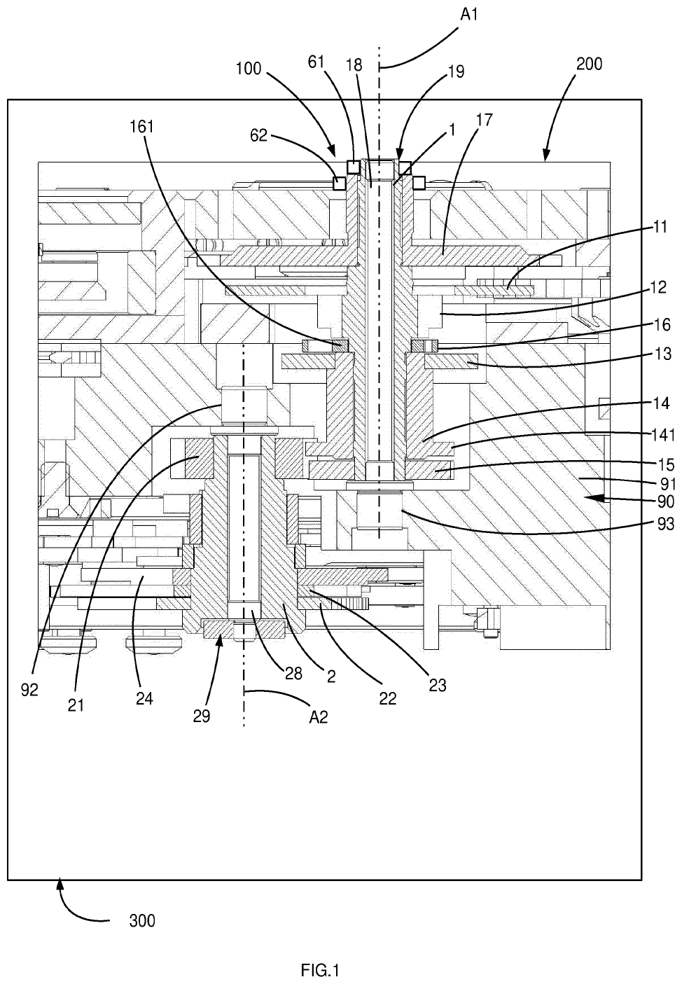

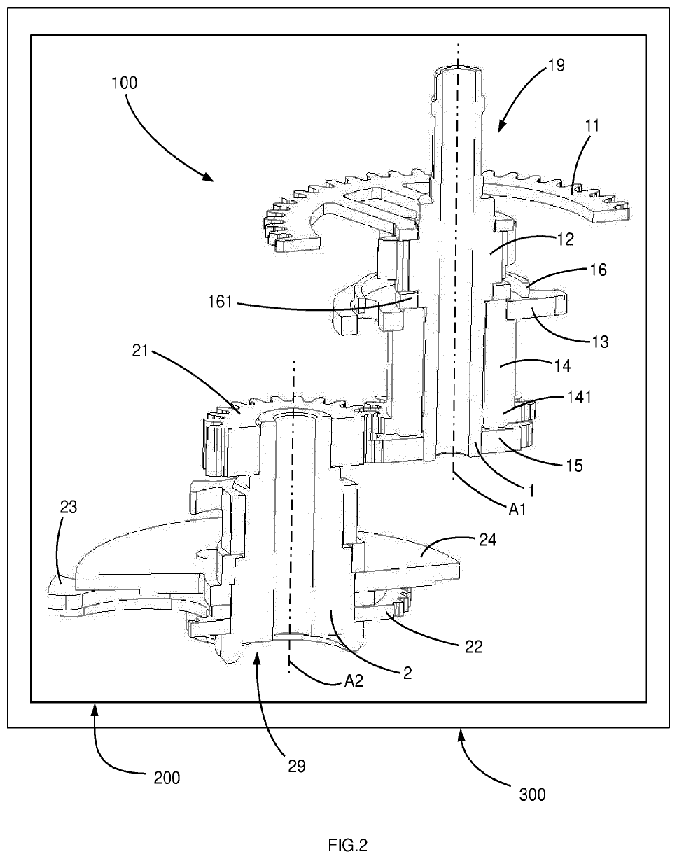

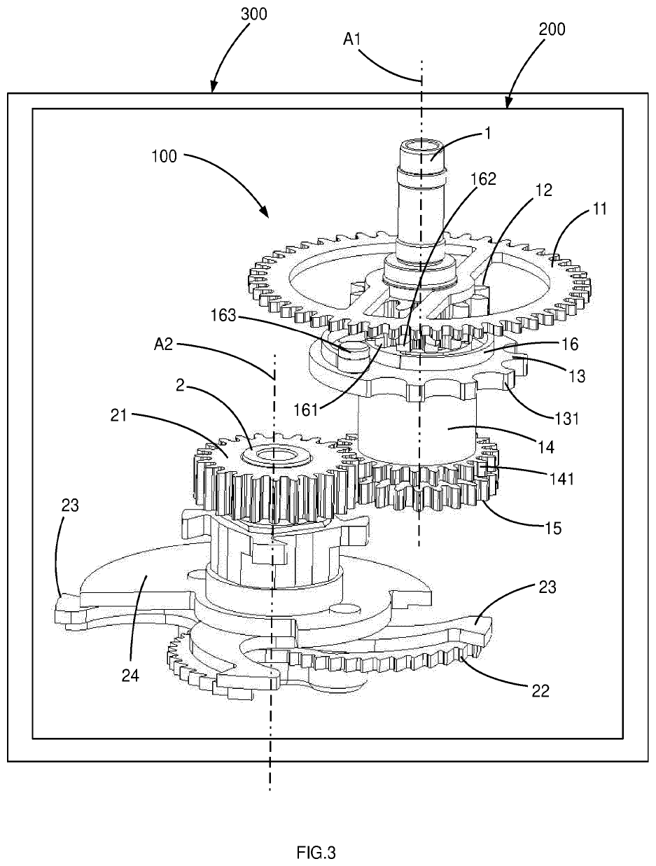

One embodiment of a timepiece 300 is described below in detail with reference to FIGS. 1 to 4. The timepiece 300 is for example a watch, particularly a wristwatch and/or a timepiece, with striking. The timepiece 300 comprises a striking timepiece movement 200, intended to be mounted in a case or a casing of a timepiece in order to protect it from the external environment. The timepiece movement 200 may be a mechanical movement, in particular an automatic movement.

The timepiece movement 200 comprises:
a frame 90, notably an ebauche or a mainplate 91,
a first cannon pinion mobile 19,
a second cannon pinion mobile 29,
a finishing gear 99 driving one of the first and second cannon pinion mobiles.

The first cannon pinion mobile 19 comprises a first cannon pinion 1. The first cannon pinion mobile, particularly the first cannon pinion 1, is able to pivot on the frame 90, notably on a first pivot 18 mounted, notably driven, for example via its end 93, into the frame 90. The first pivot 18 may be a central tube. The first cannon pinion mobile 19 comprises various elements 11, 12, 13, 14, 15, 16, 17 mounted on the first cannon pinion 1. The first cannon pinion mobile 19 is advantageously mounted on the dial side of the frame 90.

The second cannon pinion mobile 29 comprises a second cannon pinion 2. The second cannon pinion mobile, particularly the second cannon pinion 2, is able to pivot on the frame 90, notably on a second pivot 28 mounted, notably driven, for example via its end 92, into the frame 90. The second cannon pinion mobile 29 may comprise various elements 21, 22, 23, 24 mounted on the second cannon pinion 2. The second cannon pinion mobile 29 is advantageously mounted on the bridge side of the frame 90.

In other words, the timepiece movement 200 comprises a mechanism 100 comprising:
the first cannon pinion 1 or the first cannon pinion mobile 19, and
the second cannon pinion 2 or the second cannon pinion mobile 29.

The mechanism 100 also comprises:
a geared connection 14, 15, 21, notably a connection by direct gearing (or gearing without an intermediate wheel), between the first cannon pinion 1 and the second cannon pinion 2, and
a device 16 for compensating for the lash in the geared connection.

As depicted in the figures, the first cannon pinion mobile 19 is advantageously mounted on the pivot 18 driven into the frame 90 and defining a first axis A1 of rotation of the first cannon pinion mobile 19 relative to the frame 90.

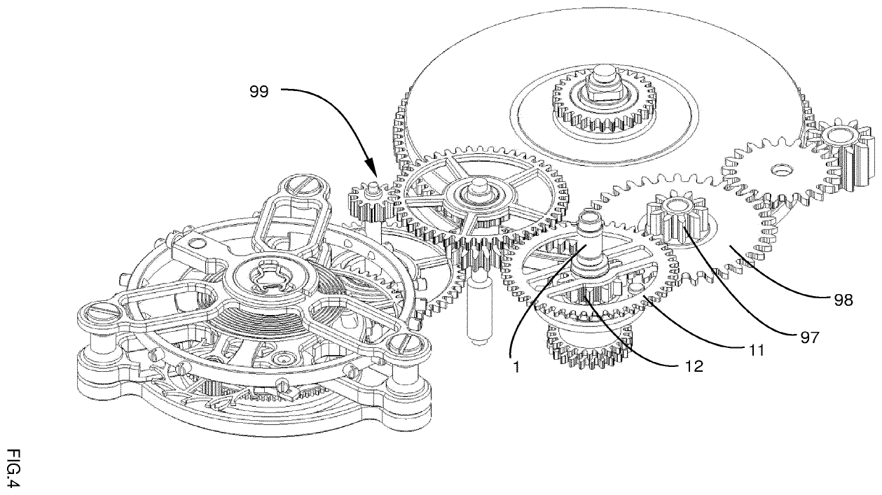

The first cannon pinion mobile 19 preferably comprises:
the first cannon pinion 1,
a first cannon-pinion wheel 11 mounted as a friction fit on the cannon pinion 1 and arranged to mesh with the finishing gear 99 (as depicted in FIG. 4 with the hours wheel 17 removed) or to form part of the finishing gear 99,
a cannon-pinion pinion 12 of one piece with the first cannon pinion 1 or fixed, notably driven, onto the first cannon pinion 1, this pinion 12 being arranged to mesh with a minute wheel 98 of a minute mobile (as depicted in FIG. 4 with the hours wheel 17 removed),
a second gearwheel 14 mounted with the ability to rotate on the first cannon pinion 1 about the axis A1, the second gearwheel 14 comprising a toothset 141 and a plate 13, the toothset 141 being arranged to mesh with a gearwheel 21 of the second cannon pinion,
a third gearwheel 15 of one piece with the first cannon pinion 1 or fixed, notably driven, onto the first cannon pinion 1, this wheel 15 being arranged to mesh with the wheel 21 of the second cannon pinion 2,
an hours wheel 17 mounted with the ability to rotate on the first cannon pinion 1 about the axis A1, the hours wheel 17 being arranged to mesh with a minute pinion 97 of the minute mobile,
an hour hand 62 fixed, notably driven, onto the hours wheel, and
a minute hand 61 fixed, notably driven, onto the first cannon pinion 1.

The second cannon pinion mobile 29 preferably comprises:
the second cannon pinion 2,
a fourth gearwheel 21 of one piece with the second cannon pinion 1 or fixed, notably driven, onto the second cannon pinion 2, this wheel 21 being arranged to mesh with the above-mentioned wheels 14 and 15.

As a preference, the geared connection 14, 15, 21 between the first cannon pinion 1 and the second cannon pinion 2 comprises:
the third gearwheel 15 fixed on the first cannon pinion 1,
the second gearwheel 14 pivot-mounted relative to the first cannon pinion 1, and
a fourth gearwheel 21 fixed on the second cannon pinion 2.

The second and third gearwheels 14, 15 mesh with the fourth wheel 21.

As a preference, the device 16 for compensating for the lash in the geared connection is arranged in such a way as to apply a return force returning the second and third wheels 14, 15 against:
the opposite flanks of at least one tooth of the fourth wheel 21, and/or
the adjacent flanks of at least two consecutive teeth of the fourth wheel 21.

Advantageously, the lash-compensation device 16 may comprise a spring 16, notably a leaf spring 16, fixed:
firstly, notably at one of its ends, to the first cannon pinion 1, and
secondly, notably at the other of its ends, to the second wheel 14.

More specifically, the spring 16 may be fixed at a first of its ends to the second wheel 14 using a pin 163.

In addition, the spring 16 may be fixed at the second of its ends to the first cannon pinion by means of a ring 161 driven over the cannon pinion.

The lash-compensation device 16 comprises an element 131 for regulating the return force. For this purpose, the plate 13 may have a set of notches 131 for rotating the second wheel 14 relative to the first cannon pinion. This set of notches may be manipulated using a tool. The manipulation may be in one direction or the other about the axis A1. Once the spring 16 has been deformed in order to obtain the desired intensity of return force:
the second gearwheel 14 and the third gearwheel 15, on the one hand, and
the fourth gearwheel 21 on the other,
   are placed in mesh with preload. The second wheel is therefore in meshing contact with the fourth wheel and the third wheel is then in meshing contact with the fourth wheel. The toothsets are therefore preloaded. It should be noted that the return force needs to be set to a value just sufficient to avoid any play between the first and second cannon pinions one relative to the other, under normal conditions of use of the timepiece. Specifically, a high-intensity return force leads to energy losses and, in consequence, to a loss in the energy autonomy of the timepiece.

In the embodiment described above, use is made of an angular return element that returns two toothsets against one another in order to achieve lash-free meshing. However, as a variant, other means of achieving lash-free meshing may be employed. It is notably possible to use, on the first cannon pinion and/or on the second cannon pinion, toothsets with flexible teeth, notably toothsets the teeth of which are slit in the direction of their height.

In the embodiment described above, the lash-compensation device 16, namely the preload device, is arranged on the first cannon pinion. As an alternative, whatever the embodiment or variant, the lash-compensation device 16 may be arranged on the second cannon pinion.

Whatever the embodiment or variant, the transmission ratio of the gearing connecting the first and second cannon pinions is advantageously 1.

Whatever the embodiment or variant, the second cannon pinion may bear just one snail.

In the embodiment described above, the finishing gear drives the first cannon pinion which itself drives the second cannon pinion. As an

1. A mechanism for a striking timepiece movement, comprising:
a first cannon pinion,
a second cannon pinion,
a geared connection between the first cannon pinion and the second cannon pinion, and
a lash-compensating device for compensating a lash in the geared connection,
wherein the geared connection comprises:
a first wheel fixed on the first cannon pinion,
a second wheel pivot-mounted relative to the first cannon pinion, and
a third wheel fixed on the second cannon pinion,
the first and second wheels meshing with the third wheel, and
wherein the lash-compensating device is arranged so as to apply a return force returning the first and second wheels against:
opposite flanks of at least one tooth of the third wheel, and/or
adjacent flanks of at least two consecutive teeth of the third wheel.

2. The mechanism as claimed in claim 1, wherein the lash-compensation device comprises a regulating element for regulating the return force.

3. The mechanism as claimed in claim 1, wherein the lash-compensation device comprises a spring, wherein the spring is fixed:
firstly, to the first cannon pinion, and
secondly, to the second wheel.

4. The mechanism as claimed in claim 3, wherein the spring has a first end and a second end, and is fixed:
at the first end, to the second wheel using a pin, and
at the second end, to the first cannon pinion via a ring that belongs to the spring.

5. The mechanism as claimed in claim 1, wherein the first cannon pinion is adapted to take a first minutes indicator.

6. The mechanism as claimed in claim 1, wherein the second cannon pinion is adapted to take at least a striking-work cam.

7. A timepiece movement comprising:
the mechanism as claimed in claim 1, and
a finishing gear driving one of the first cannon pinion or the second cannon pinion.

8. The timepiece movement as claimed in claim 7, wherein the movement comprises a frame, wherein the first cannon pinion is mounted on a dial side of the frame and the second cannon pinion is mounted on a bridge side of the frame.

9. A timepiece, comprising the mechanism as claimed in claim 1.

10. The mechanism as claimed in claim 2, wherein the regulating element comprises grippable notching adapted to allow the second gearwheel to be rotated relative to the first cannon pinion.

11. The mechanism as claimed in claim 3, wherein the spring has a first end and a second end, and is fixed:
at the first end, to the first cannon pinion, and
at the second end, to the second wheel.

12. The mechanism as claimed in claim 11, wherein the spring is fixed:
at the first end, to the second wheel using a pin, and
at the second end, to the first cannon pinion via a ring that belongs to the spring.

13. The mechanism as claimed in claim 5, wherein the first minutes indicator is a minute hand.

14. The mechanism as claimed in claim 6, wherein the striking-work cam is a minutes snail and/or a surprise piece and/or a quarter-hour snail.

15. The mechanism as claimed in claim 2, wherein the lash-compensation device comprises a spring, wherein the spring is fixed:
firstly, to the first cannon pinion, and
secondly, to the second wheel.

16. The mechanism as claimed in claim 15, wherein the spring has a first end and a second end, and is fixed:
at the first end, to the second wheel using a pin, and
at the second end, to the first cannon pinion via a ring that belongs to the spring.

17. The mechanism as claimed in claim 2, wherein the first cannon pinion is adapted to take a first minutes indicator.

18. The mechanism as claimed in claim 3, wherein the first cannon pinion is adapted to take a first minutes indicator.

19. The mechanism as claimed in claim 2, wherein the second cannon pinion is adapted to take at least a striking-work cam.

20. The mechanism as claimed in claim 3, wherein the second cannon pinion is adapted to take at least a striking-work cam.
